(19) United States
(12) Patent Application Publication
(10) Pub. No.: US 2019/0389981 A1
(43) Pub. Date: Dec. 26, 2019

(54) PRODUCTION METHOD AND PRODUCTION DEVICE FOR POLYMER

(71) Applicant: ZEON CORPORATION, Chiyoda-ku Tokyo (JP)

(72) Inventors: Masanobu KANAUCHI, Chiba-shi, Chiba (JP); Ryuichi ONO, Nakano-ku, Tokyo (JP)

(73) Assignee: ZEON CORPORATION, Chiyoda-ku Tokyo (JP)

(21) Appl. No.: 16/480,815

(22) PCT Filed: Jan. 19, 2018
(86) PCT No.: PCT/JP2018/001546

§ 371 Date: Jul. 25, 2019

(30) Foreign Application Priority Data
Feb. 1, 2017 (JP) 2017-017070

(51) Int. Cl. C08F 2/01; C08F 36/06; C08F 6/12; C08F 6/10; C08F 2/06

(52) U.S. Cl. CPC C08F 2/01; C08F 36/06; C08F 2/06; C08F 6/10; C08F 6/12

(57) ABSTRACT

A production method for a polymer comprises: a step (A) of polymerizing a raw material monomer to obtain a polymer-containing liquid containing a polymer; a step (B) of separating a collection target component-containing fluid containing a collection target component composed of at least one of a solvent and a residual monomer, from the polymer-containing liquid; a step (C) of supplying the collection target component-containing fluid to a three-product distillation column, and separating a fraction containing an impurity higher in boiling point than the collection target component and a fraction containing an impurity lower in boiling point than the collection target component, to obtain a fraction containing the collection target component of high purity; and a step (D) of performing polymerization using the fraction containing the collection target component of high purity.

### TECHNICAL FIELD

The present disclosure relates to a production method and a production device for a polymer, and particularly relates to a production method and a production device for a polymer that separate and collect at least one of a residual monomer (unreacted raw material monomer) and a solvent from a polymer-containing liquid obtained by polymerizing a raw material monomer and reuse it.

### BACKGROUND

A technique of, in a process of producing a polymer such as rubber by solution polymerization, separating and collecting an organic solvent used in the solution polymerization from a polymer-containing liquid obtained by the solution polymerization and reusing the organic solvent has been proposed conventionally (for example, see NPL 1).

### CITATION LIST

### Non Patent Literature

NPL 1: Carl G. Hagberg, “Comparison of solution rubber finishing processes—part I”, Process Machinery, March 2000, p. 17-23.

### SUMMARY

### Technical Problem

Regarding the production process described in NPL 1, the technique of separating and collecting the solvent from the polymer-containing liquid has not been studied in detail. Besides, the production process does not involve separating and collecting a residual monomer from the polymer-containing liquid and reusing the residual monomer.

For cost reduction and environmental load reduction in the polymer production process, it is necessary to develop a technique of efficiently separating and collecting the solvent and/or the residual monomer contained in the polymer-containing liquid and reusing it.

It could therefore be helpful to provide a technique of efficiently separating and collecting at least one of a residual monomer and a solvent from a polymer-containing liquid obtained by polymerizing a raw material monomer and reusing it.

### Solution to Problem

To advantageously solve the problem stated above, a production method for a polymer according to the present disclosure comprises: a step (A) of polymerizing a raw material monomer to obtain a polymer-containing liquid containing a polymer; a step (B) of separating a collection target component-containing fluid containing a collection target component composed of at least one of a solvent and a residual monomer, from the polymer-containing liquid; a step (C) of supplying the collection target component-containing fluid to a three-product (Petlyuk) distillation column, and separating a fraction containing an impurity higher in boiling point than the collection target component and a fraction containing an impurity lower in boiling point than the collection target component, to obtain a fraction containing the collection target component of high purity; and a step (D) of performing polymerization using the fraction containing the collection target component of high purity. Thus, by subjecting the collection target component-containing fluid separated from the polymer-containing liquid to fractional distillation in the three-product distillation column to obtain the fraction containing the collection target component of high purity, the collection target component can be efficiently separated and collected from the polymer-containing liquid and reused for the polymerization of the polymer.

Preferably, in the production method for a polymer according to the present disclosure, the collection target component-containing fluid contains a first collection target component and a second collection target component lower in vapor pressure than the first collection target component, and the step (C) includes: a step (c1) of supplying the collection target component-containing fluid to a first three-product distillation column, and obtaining a fraction containing an impurity lower in boiling point than the first collection target component, a fraction containing the first collection target component of high purity, and a fraction containing the second collection target component; and a step (c2) of supplying the fraction containing the second collection target component to a second three-product distillation column, and obtaining a fraction containing an impurity higher in boiling point than the second collection target component, a fraction containing the second collection target component of high purity, and a fraction containing an impurity lower in boiling point than the second collection target component. In the case where the collection target component-containing fluid contains a plurality of collection target components (the first collection target component and the second collection target component) that differ in vapor pressure, by separating and collecting the first collection target component higher in vapor pressure than the second collection target component using the first three-product distillation column and the second three-product distillation column before the second collection target component, the collection target components can be separated and collected easily without an increase in the operating pressure of the three-product distillation columns.

Preferably, in the production method for a polymer according to the present disclosure, the collection target component-containing fluid contains the solvent and the residual monomer, and the step (C) includes: a step (c3) of obtaining a fraction containing the residual monomer of high purity using the three-product distillation column; and a step (c4) of obtaining a fraction containing the solvent of high purity using the three-product distillation column, after the step (c3). In the case where the collection target component-containing fluid contains both the solvent and the residual monomer as the collection target component, by separating and collecting the residual monomer first, the occurrence of side reaction such as the formation of polymerization foreign matter of the residual monomer during the fractional distillation can be prevented.

In the production method for a polymer according to the present disclosure, the solvent may be an organic compound with a carbon number of 4 or more and 7 or less.

In the production method for a polymer according to the present disclosure, the raw material monomer may have a carbon number of 4 or more and 5 or less.

To advantageously solve the problem stated above, a production device for a polymer according to the present disclosure comprises: a polymerization portion including a reactor that polymerizes a raw material monomer; a separation portion including a separator that separates, from a polymer-containing liquid containing a polymer obtained by the polymerization portion, a collection target component-containing fluid containing a collection target component composed of at least one of a solvent and a residual monomer; a three-product distillation portion including a three-product distillation column supplied with the collection target component-containing fluid obtained by the separation portion, and separating, from the collection target component-containing fluid, a fraction containing an impurity higher in boiling point than the collection target component and a fraction containing an impurity lower in boiling point than the collection target component, to obtain a fraction containing the collection target component of high purity; and a return line that supplies the fraction containing the collection target component of high purity to the reactor. Thus, with the separation portion, the three-product distillation portion, and the return line, the collection target component can be efficiently separated and collected from the polymer-containing liquid and reused for the polymerization of the polymer.

In the present disclosure, “high purity” denotes that the concentration of the collection target component is higher than the concentration of the collection target component in the collection target component-containing fluid. In the present disclosure, “fractional distillation” denotes dividing the distilland into three or more fractions in one distillation operation. A non-limiting example of the “three-product (Petlyuk) distillation column” is a divided-wall distillation column.

In the present disclosure, in the case where the collection target component-containing fluid contains a plurality of collection target components, “higher in boiling point than the collection target component” denotes that the boiling point is higher than that of the collection target component highest in boiling point of the plurality of collection target components, and “lower in boiling point than the collection target component” denotes that the boiling point is lower than that of the collection target component lowest in boiling point of the plurality of collection target components. cl Advantageous Effect

With the production method and production device for a polymer according to the present disclosure, at least one of a residual monomer and a solvent can be efficiently separated and collected from a polymer-containing liquid obtained by polymerizing a raw material monomer and reused.

### BRIEF DESCRIPTION OF THE DRAWINGS

In the accompanying drawings:

FIG. 1 is a diagram illustrating the schematic structure of an example of a production device for a polymer according to the present disclosure;

FIG. 2 is a diagram illustrating the schematic structure of another example of the production device for a polymer according to the present disclosure; and

FIG. 3 is a diagram illustrating the schematic structure of a production device for a polymer used in Comparative Example 1.

### DETAILED DESCRIPTION

One of the disclosed embodiments will be described in detail below.

A production method for a polymer according to the present disclosure can be used when producing a polymer while separating and collecting at least one of a residual monomer and a solvent from a polymer-containing liquid obtained by polymerizing a raw material monomer and reusing it. A polymerization device according to the present disclosure is, for example, suitable for use when producing a polymer using the production method for a polymer according to the present disclosure. In terms of cost reduction and environmental load reduction in the polymer production, the production method and production device for a polymer according to the present disclosure preferably separate and collect both of the solvent and the residual monomer and reuse them.

Non-limiting examples of the polymer that can be produced according to the present disclosure include homopolymers such as polybutadiene (BR) and polyisoprene (IR) and copolymers such as styrene-butadiene copolymer (SBR) and acrylonitrile-butadiene copolymer (NBR).

In the present disclosure, the polymer can be produced using any polymerization method. Specifically, in the present disclosure, the polymer can be produced using a polymerization method that uses a solvent, such as solution polymerization, emulsion polymerization, or suspension polymerization, or a polymerization method that does not use a solvent, such as bulk polymerization.

Non-limiting examples of the solvent usable for the polymerization of the polymer in the present disclosure include water, an organic solvent, and a mixture thereof. Non-limiting examples of the organic solvent include organic compounds with a carbon number of 4 or more and 7 or less such as butane and hexane.

In the case of producing the polymer using solution polymerization, an organic solvent is typically used as the solvent. In the case of producing the polymer using emulsion polymerization or suspension polymerization, water is typically used as the solvent.

Non-limiting examples of the raw material monomer usable for the polymerization of the polymer in the present disclosure include one type of monomer and a mixture of two or more types of monomers capable of forming the desired polymer. Specifically, examples of the raw material monomer include: monomers with a carbon number of 4 or more and 5 or less such as 1,3-butadiene and isoprene; styrene; and acrylonitrile.

### Production Method For Polymer

The production method for a polymer according to the present disclosure includes: a step (A) of polymerizing a raw material monomer to obtain a polymer-containing liquid containing a polymer; and a step (B) of separating a collection target component-containing fluid containing a collection target component composed of at least one of a solvent and a residual monomer from the polymer-containing liquid obtained in the step (A). The production method for a polymer according to the present disclosure further includes: a step (C) of supplying the collection target component-containing fluid obtained in the step (B) to a three-product distillation column, and separating a fraction containing an impurity higher in boiling point than the collection target component and a fraction containing an impurity lower in boiling point than the collection target component, to obtain a fraction containing the collection target component of high purity; and a step (D) of performing polymerization using the fraction containing the collection target component of high purity obtained in the step (C).

With the production method for a polymer according to the present disclosure, the three-product distillation column is used when separating and collecting the fraction containing the collection target component of high purity from the collection target component-containing fluid in the step (C), so that the collection target component can be efficiently separated and collected. Moreover, with the production method for a polymer according to the present disclosure, the three-product distillation column is used in the step (C), and therefore the heat load on the collection target component can be reduced as compared with the case of separating and collecting the fraction containing the collection target component of high purity from the collection target component-containing fluid using a device formed by series-connecting a plurality of distillation columns each for dividing the distilland into two fractions in one distillation operation. In the case of separating and collecting the residual monomer as the collection target component in the production method for a polymer according to the present disclosure, the occurrence of side reaction such as the formation of polymerization foreign matter during the separation and collection of the fraction containing the collection target component can be prevented. Consequently, contamination and clogging caused by the formation of polymerization foreign matter and the like can be prevented, with it being possible to reduce the frequency of cleaning the device such as the three-product distillation column.

### Step (A)

In the step (A), the raw material monomer is polymerized in the presence or absence of the solvent, to obtain the polymer-containing liquid containing the polymer. The polymer in the polymer-containing liquid may be dissolved in the residual monomer or the solvent, or dispersed in the residual monomer or the solvent. That is, the polymer-containing liquid may be a polymer solution, or a polymer dispersion such as latex. In the case where the raw material monomer is polymerized in the presence of the solvent in the step (A), at least one of the solvent and the residual monomer used in the polymerization is the collection target component. In the case where the raw material monomer is polymerized in the absence of the solvent in the step (A), the residual monomer is the collection target component.

Non-limiting examples of each of the solvent, the raw material monomer, and the polymerization method used in the step (A) and the polymer obtained in the step (A) are as described above.

### Step (B)

In the step (B), the collection target component-containing fluid containing the collection target component is separated from the polymer-containing liquid obtained in the step (A).

Non-limiting examples of the method of separating the collection target component-containing fluid from the polymer-containing liquid include (1) a method of evaporation-separating the collection target component-containing fluid from the polymer-containing liquid by heating devolatilization, and (2) a method of coagulating the polymer using water, alcohol, or the like and then evaporation-separating the collection target component-containing fluid from the polymer-containing liquid by vapor blowing.

### Step (C)

In the step (C), the collection target component-containing fluid obtained in the step (B) is supplied to the three-product distillation column, and the fraction containing the impurity higher in boiling point than the collection target component and the fraction containing the impurity lower in boiling point than the collection target component are separated to obtain the fraction containing the collection target component of high purity.

As the three-product distillation column, a distillation column capable of dividing the distilland into three or more fractions and preferably into three fractions may be used. Specifically, the three-product distillation column used may be, for example, a distillation column that discharges a high boiling point component from the column bottom, an intermediate boiling point component from the column center region, and a low boiling point component from the column top as described in JP 2016-524522 A.

More specifically, the three-product distillation column may be, but is not limited to, a divided-wall column (DWC) having a division wall arranged in the length direction. The division wall of the divided-wall column divides, for example, the inside of the column into a feed section (the left side of the division wall), a removal section (the right side of the division wall), an upper joint column section (rectification section), and a lower joint column section (stripping section). In the divided-wall column, a supply port (feed inlet) for supplying the distilland is typically located in the center region of the feed section (i.e. between the upper region and the lower region of the feed section). A side stream extraction portion is typically located in the center region of the removal section of the divided-wall column (i.e. between the upper region and the lower region of the removal section).

One or more supply ports (feed inlets) may be further provided in the center region of the feed section. One or more side stream extraction portions may be further provided in the center region of the removal section.

In the step (C), in the case where the collection target component-containing fluid contains only one type of collection target component, typically one three-product distillation column is used to obtain the fraction containing the collection target component of high purity. In the step (C), in the case where the collection target component-containing fluid contains two or more types of collection target component, one three-product distillation column may be used to obtain the fraction containing the collection target component of high purity, or two or more three-product distillation columns may be used to obtain the fraction containing the collection target component of high purity.

In the step (C), to obtain the fraction containing the collection target component of high purity more suitable for reuse, both the fraction containing the impurity higher in boiling point than the collection target component and the fraction containing the impurity lower in boiling point than the collection target component are separated from the collection target component-containing fluid, thus obtaining the fraction containing the collection target component of high purity.

In the case of separating both the fraction containing the impurity higher in boiling point than the collection target component and the fraction containing the impurity lower in boiling point than the collection target component from the collection target component-containing fluid using one three-product distillation column, the fraction discharged from the column bottom of the three-product distillation column is the fraction containing the impurity higher in boiling point than the collection target component, the fraction discharged from the column top of the three-product distillation column is the fraction containing the impurity lower in boiling point than the collection target component, and the fraction discharged from the column center region of the three-product distillation column is the fraction containing the collection target component of high purity.

In the case of obtaining the fraction containing the collection target component of high purity using two or more three-product distillation columns, in the step (C), a plurality of fractions containing the collection target component of high purity can be obtained using the three-product distillation columns series-connected to each other.

The use of two or more three-product distillation columns in the step (C) is particularly advantageous in the case where the collection target component-containing fluid contains two or more types of collection target components and also contains an impurity having a boiling point (T_{L}<T<T_{H}) between the boiling point (T_{H}) of the collection target component highest in boiling point and the boiling point (T_{L}) of the collection target component lowest in boiling point. For example, in the case of using a three-product distillation column that divides the distilland into three fractions, if the collection target component-containing fluid contains an impurity having a boiling point of more than T_{L} and less than T_{H} (hereafter also referred to as “intermediate boiling point impurity”), the intermediate boiling point impurity cannot be efficiently separated by one three-product distillation column alone, and may enter the fraction containing the collection target component of high purity. However, by repeating fractional distillation using a plurality of three-product distillation columns, for example, it is possible to obtain, in the first three-product distillation column, the fraction containing the impurity lower in boiling point than the collection target component, the fraction containing the collection target component of high purity (collection target component whose boiling point is T_{L}), and the fraction containing the collection target component whose boiling point is T_{H}, the intermediate boiling point impurity, and the impurity higher in boiling point than the collection target component, and then obtain, in the second three-product distillation column, the fraction containing the intermediate boiling point impurity, the fraction containing the collection target component of high purity (collection target component whose boiling point is T_{H}), and the fraction containing the impurity higher in boiling point than the collection target component. Thus, the fraction containing the collection target component of high purity can be obtained while efficiently separating the intermediate boiling point impurity.

In the case of separating, using two or more three-product distillation columns (n columns, where n≥2), the fraction containing the impurity higher in boiling point than the collection target component and the fraction containing the impurity lower in boiling point than the collection target component from the collection target component-containing fluid, the fraction discharged from the column top of the first three-product distillation column is the fraction containing the impurity lower in boiling point than the collection target component, the fraction discharged from the column bottom of the last (nth) three-product distillation column is the fraction containing the impurity higher in boiling point than the collection target component, and the fraction containing the collection target component of high purity is obtained between the column center region of the first fractional distillation column and the column center region of the last (nth) three-product distillation column. Alternatively, the fraction discharged from the column bottom of the first fractional distillation column is the fraction containing the impurity higher in boiling point than the collection target component, the fraction discharged from the column top of the last (nth) three-product distillation column is the fraction containing the impurity lower in boiling point than the collection target component, and the fraction containing the collection target component of high purity is obtained between the column center region of the first three-product distillation column and the column center region of the last (nth) three-product distillation column.

In the production method for a polymer according to the present disclosure, particularly in the case where the collection target component-containing fluid contains a first collection target component and a second collection target component lower in vapor pressure than the first collection target component, it is preferable to, in the step (C), use the first three-product distillation column and the second three-product distillation column and separate and collect the fraction containing the first collection target component of high purity before the fraction containing the second collection target component of high purity. In detail, the step (C) preferably includes: a step (c1) of supplying the collection target component-containing fluid to the first three-product distillation column and obtaining the fraction containing the impurity lower in boiling point than the first collection target component, the fraction containing the first collection target component of high purity, and the fraction containing the second collection target component; and a step (c2) of supplying the fraction containing the second collection target component to the second three-product distillation column and obtaining the fraction containing the impurity higher in boiling point than the second collection target component, the fraction containing the second collection target component of high purity, and the fraction containing the impurity lower in boiling point than the second collection target component. By performing the steps (c1) and (c2) using the first three-product distillation column and the second three-product distillation column and separating and collecting the first collection target component higher in vapor pressure first, the collection target components can be separated and collected easily without an increase in the operating pressure of the three-product distillation columns.

In the production method for a polymer according to the present disclosure, particularly in the case where the collection target component-containing fluid contains both the solvent and the residual monomer as the collection target component, it is preferable to, in the step (C), use two or more three-product distillation columns and separate and collect the fraction containing the residual monomer of high purity before the fraction containing the solvent of high purity. In detail, the step (C) preferably includes: a step (c3) of obtaining the fraction containing the residual monomer of high purity using the three-product distillation column; and a step (c4) of obtaining the fraction containing the solvent of high purity using the three-product distillation column after the step (c3). By separating and collecting the residual monomer first, the heat load on the residual monomer separated and collected in the step (C) can be reduced as compared with the case of separating and collecting the solvent first. Consequently, the occurrence of side reaction such as the formation of polymerization foreign matter of the residual monomer during the fractional distillation can be prevented.

In the step (C) in the production method for a polymer according to the present disclosure, in the case where the collection target component-containing fluid contains the residual monomer as the collection target component, the fractional distillation may be performed in the presence of a polymerization inhibitor such as 4-tert-butylcatechol (TBC) or diethylhydroxyamine (DEHA), without being limited thereto. By performing the fractional distillation in the presence of a polymerization inhibitor, the occurrence of side reaction such as the formation of polymerization foreign matter of the residual monomer can be prevented. Usually, the operating pressure and temperature when performing fractional distillation are higher than the operating pressure and temperature when performing normal distillation. Accordingly, side reaction tends to occur in the fractional distillation. By performing the fractional distillation in the presence of a polymerization inhibitor, however, the occurrence of side reaction during the fractional distillation can be prevented, and the device for performing the fractional distillation, such as the three-product distillation column, can be prevented from contamination and clogging.

In the case where the polymerization inhibitor is used in the step (C), the polymerization inhibitor may enter the fraction containing the collection target component of high purity. In such a case, the polymerization inhibitor is removed from the fraction containing the collection target component of high purity by any method such as distillation or aqueous cleaning, before the below-described step (D).

### Step (D)

In the step (D), the polymerization of the polymer is performed using the fraction containing the collection target component of high purity obtained in the step (C).

In the step (D), the polymerization of the polymer can be performed in the same way as in the step (A) except that the fraction containing the collection target component of high purity obtained in the step (C) is reused as part of the solvent and/or the raw material monomer, without being limited thereto.

In the step (D), the polymerization of the polymer may be performed under conditions different from the step (A), and the polymerization of a different type of polymer from the step (A) may be performed, as long as the fraction containing the collection target component of high purity obtained in the step (C) is used.

### Production Device For Polymer

The production device for a polymer according to the present disclosure is suitable for use when producing a polymer using the foregoing production method for a polymer. The production device for a polymer according to the present disclosure includes: a polymerization portion including a reactor that polymerizes a raw material monomer; a separation portion including a separator that separates, from a polymer-containing liquid containing a polymer obtained by the polymerization portion, a collection target component-containing fluid containing a collection target component composed of at least one of a solvent and a residual monomer; a three-product distillation portion including a three-product distillation column supplied with the collection target component-containing fluid obtained by the separation portion, and separating, from the collection target component-containing fluid, a fraction containing an impurity higher in boiling point than the collection target component and a fraction containing an impurity lower in boiling point than the collection target component, to obtain a fraction containing the collection target component of high purity; and a return line that supplies the fraction containing the collection target component of high purity to the reactor.

### Polymerization Portion

The polymerization portion can perform the steps (A) and (D) of the production method for a polymer according to the present disclosure. As the reactor of the polymerization portion, for example, a reactor capable of polymerizing a raw material monomer, such as a polymerization can, may be used, without being limited thereto.

### Separation Portion

The separation portion can perform the step (B) of the production method for a polymer according to the present disclosure. As the separator of the separation portion, for example, a vapor stripping device or a devolatilization device may be used, without being limited thereto.

### Three-Product Distillation Portion

The three-product distillation portion can perform the step (C) of the production method for a polymer according to the present disclosure. As the three-product distillation column of the three-product distillation portion, for example, a divided-wall column may be used, without being limited thereto.

The three-product distillation portion may be provided with two or more three-product distillation columns.

### Return Line

The return line is, for example, piping connecting the three-product distillation column of the three-product distillation portion and the reactor of the polymerization portion.

The production device for a polymer according to the present disclosure includes the three-product distillation portion having the three-product distillation column, so that the collection target component can be efficiently separated and collected. Moreover, since the production device for a polymer according to the present disclosure uses the three-product distillation column, the heat load on the collection target component can be reduced as compared with the case of using a device formed by series-connecting a plurality of distillation columns each for dividing the distilland into two fractions in one distillation operation. Therefore, even in the case of separating and collecting the residual monomer as the collection target component, the contamination of the three-product distillation column or the like by the formation of polymerization foreign matter can be prevented, with it being possible to reduce the frequency of cleaning the device.

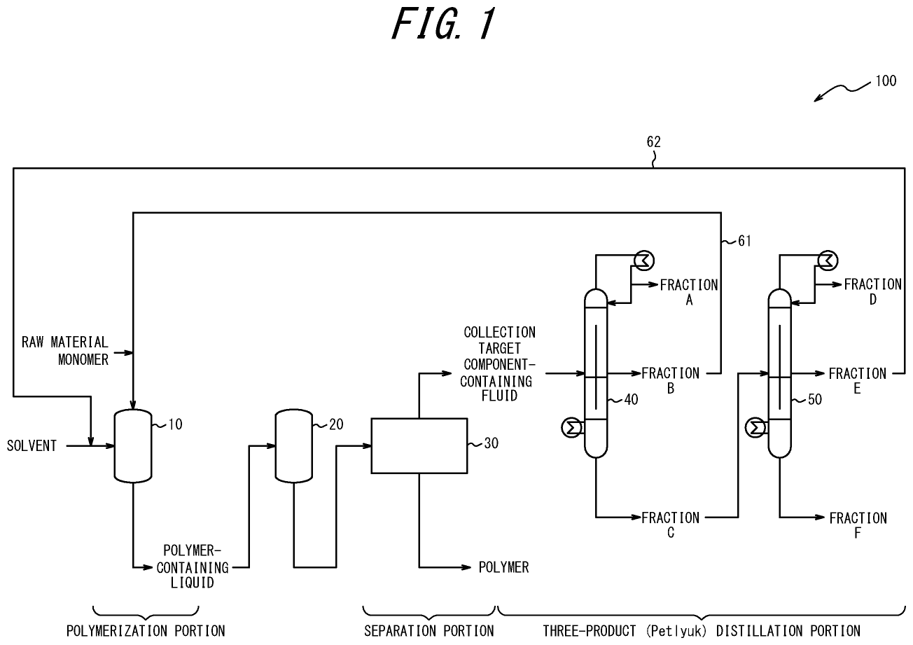

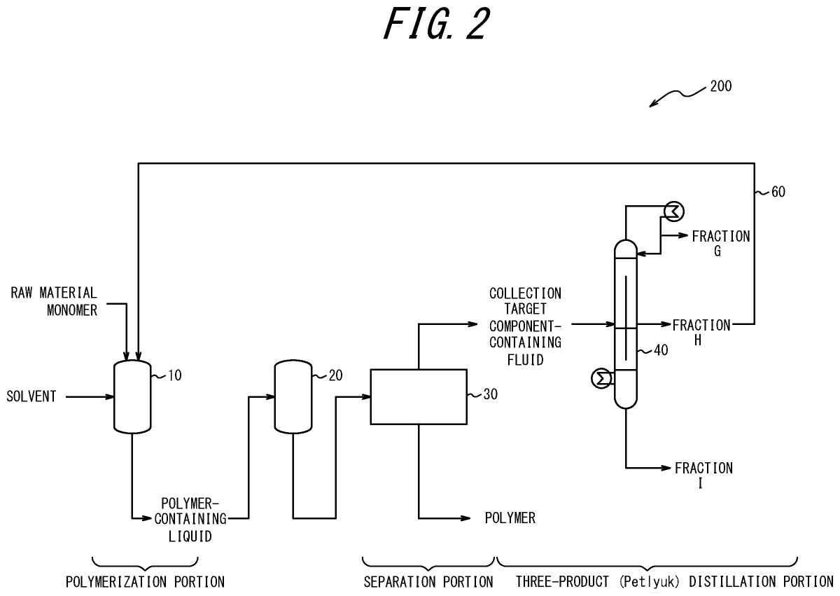

A non-limiting example of the production device for a polymer having the above-described structure is a production device 100 illustrated in FIG. 1. Another non-limiting example of the production device for a polymer having the above-described structure is a production device 200 illustrated in FIG. 2.

The production device 100 illustrated in FIG. 1 includes: a reactor 10 that is supplied with a solvent and a raw material monomer and polymerizes the raw material monomer in the presence of the solvent; a tank 20 that temporarily stores a polymer-containing liquid obtained by the reactor 10; a separator 30 that separates the polymer-containing liquid stored in the tank 20 between a collection target component-containing fluid and a polymer; a first three-product distillation column 40 into which the collection target component-containing fluid obtained by the separator 30 flows; a second three-product distillation column 50 series-connected to the first three-product distillation column 40; a first return line 61 that returns a fraction B obtained by the first three-product distillation column 40 to the reactor 10; and a second return line 62 that returns a fraction E obtained by the second three-product distillation column 50 to the reactor 10.

In the production device 100, for example, the fraction B containing the residual monomer of high purity and the fraction E containing the solvent of high purity are separated and collected from the collection target component-containing fluid containing the residual monomer and the solvent higher in boiling point than the residual monomer, and reused for the polymerization of the polymer in the reactor 10, without being limited thereto.

Specifically, in the production device 100, the first fractional distillation column 40 discharges the fraction A containing the imputhree-product in boiling point than the collection target component from the column top, discharges the fraction B containing the residual monomer of high purity from the column center region, and the fraction C containing the solvent, the intermediate boiling point impurity (impurity whose boiling point is higher than the boiling point of the residual monomer and lower than the boiling point of the solvent), and the impurity higher in boiling point than the collection target component from the column bottom. The fraction B is supplied to the reactor 10 via the first return line 61. In the production device 100, the fraction C is supplied to the second three-product distillation column 50, and the second three-product distillation column 50 discharges the fraction D containing the intermediate boiling point impurity from the column top, discharges the fraction E containing the solvent of high purity from the column center region, and discharges the fraction F containing the impurity higher in boiling point than the collection target component from the column bottom. The fraction E is supplied to the reactor 10 via the second return line 62.

For example, in the case of polymerizing polyisoprene using isoprene as the raw material monomer and hexane as the solvent in the production device 100, the impurity contained in the fraction A and lower in boiling point than the collection target component is water, the intermediate boiling point impurity contained in the fraction D is 2-methyl-2-butene, and the impurity contained in the fraction F and higher in boiling point than the collection target component is a dimer of isoprene.

The production device 200 illustrated in FIG. 2 includes: a reactor 10 that is supplied with a solvent and a raw material monomer and polymerizes the raw material monomer in the presence of the solvent; a tank 20 that temporarily stores a polymer-containing liquid obtained by the reactor 10; a separator 30 that separates the polymer-containing liquid stored in the tank 20 between a collection target component-containing fluid and a polymer; a three-product distillation column 40 into which the collection target component-containing fluid obtained by the separator 30 flows; and a return line 60 that returns a fraction H obtained by the three-product distillation column 40 to the reactor 10.

In the production device 200, for example, the fraction H containing the residual monomer and the solvent of high purity is separated and collected from the collection target component-containing fluid containing the residual monomer and the solvent, and reused for the polymerization of the polymer in the reactor 10, without being limited thereto.

Specifically, in the production device 200, the three-product distillation column 40 discharges the fraction G containing the impurity lower in boiling point than the collection target component from the column top, discharges the fraction H containing the residual monomer and the solvent of high purity from the column center region, and discharges the fraction I containing the impurity higher in boiling point than the collection target component from the column bottom. The fraction H is supplied to the reactor 10 via the return line 60.

For example, in the case of polymerizing polyisoprene using isoprene as the raw material monomer and hexane as the solvent in the production device 200, the impurity contained in the fraction G and lower in boiling point than the collection target component is water, and the impurity contained in the fraction I and higher in boiling point than the collection target component is a dimer of isoprene. In the production device 200, 2-methyl-2-butene which is the intermediate boiling point impurity is contained in the fraction H together with isoprene and hexane.

### EXAMPLES

The following will provide more specific description of the present disclosure based on examples, although the present disclosure is not limited to the following examples.

### Example 1

Polyisoprene was produced using the production device 100 illustrated in FIG. 1. Specifically, polyisoprene was polymerized using isoprene as a raw material monomer and hexane as a solvent.

In detail, isoprene as the raw material monomer and hexane as the solvent were supplied to the reactor 10 to be subjected to polymerization. 50 mass % of the raw material monomer was polymerized to yield an isoprene polymer-containing liquid. The isoprene polymer-containing liquid was temporarily stored in the tank 20, and then subjected to coagulation and vapor blowing in the separator 30 to be separated between a collection target component-containing fluid containing isoprene and hexane and a polymer (polyisoprene). Following this, the collection target component-containing fluid was supplied to the first three-product distillation column 40. The first three-product distillation column 40 discharged the fraction A containing the impurity (water) lower in boiling point than isoprene as the residual monomer from the column top, discharged the fraction B containing the residual monomer (isoprene) of high purity from the column center region, and discharged the fraction C containing the component higher in boiling point than the residual monomer from the column bottom. The fraction B was returned to the reactor 10 via the return line 61. The fraction C containing the component higher in boiling point than the residual monomer was supplied to the second three-product distillation column 50. The second three-product distillation column 50 discharged the fraction D containing the impurity (2-methyl-2-butene) lower in boiling point than the solvent (hexane) from the column top, discharged the fraction E containing the solvent (hexane) of high purity from the column center region, and discharged the fraction F containing the impurity (isoprene dimer) higher in boiling point than the solvent from the column bottom. The fraction E was returned to the reactor 10 via the return line 62.

The purity of the fraction B was 99.5%, and the weight of the fraction B was 98% of the residual isoprene weight in the isoprene polymer-containing liquid. The purity of the fraction E was 99.8%, and the weight of the fraction E was 99% of the hexane weight in the isoprene polymer-containing liquid.

### Comparative Example 1

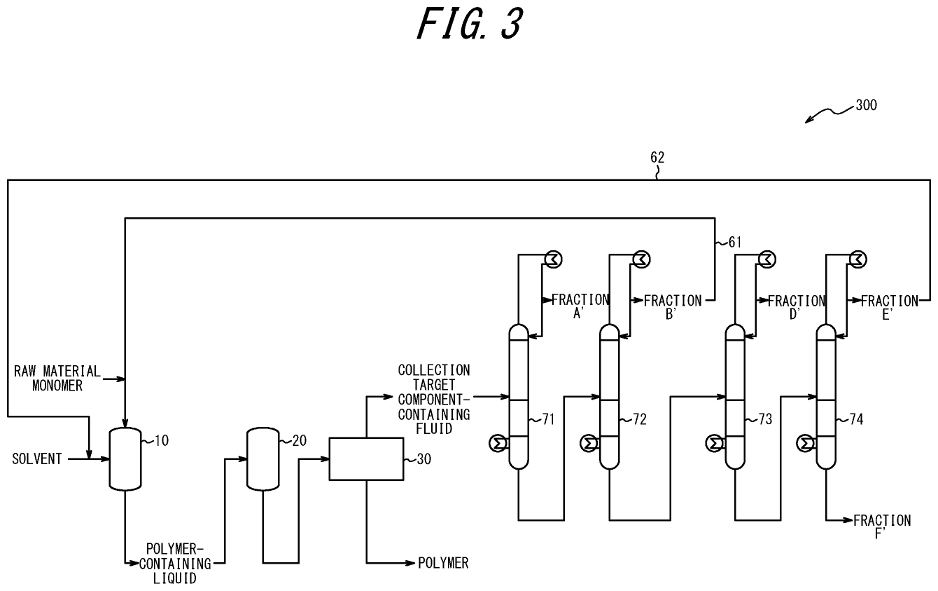

Polyisoprene was produced in the same way as in Example 1, except that a production device 300 illustrated in FIG. 3 was used instead of the production device 100 illustrated in FIG. 1.

The purity of the fraction B′ was 99.5%, and the weight of the fraction B′ was 98% of the residual isoprene weight in the isoprene polymer-containing liquid. The purity of the fraction E′ was 99.8%, and the weight of the fraction E′ was 99% of the hexane weight in the isoprene polymer-containing liquid.

The production device 300 has the same structure as the production device 100, except that the three-product distillation portion in FIG. 1 is replaced with the following impurity removal portion.

### Impurity Removal Portion

The impurity removal portion includes: a low boiling point substance removal column 71 that removes the impurity (water) lower in boiling point than the collection target component in the collection target component-containing fluid; a distillation column 72 that collects isoprene (residual monomer) as the collection target component; an intermediate boiling point substance removal column 73 that removes 2-methyl-2-butene as the intermediate boiling point impurity; and a high boiling point substance removal column 74 that removes the impurity (isoprene dimer) higher in boiling point than the collection target component and collects hexane (solvent) as the collection target component.

In the impurity removal portion, the fraction A′ containing the impurity lower in boiling point than the collection target component is discharged from the column top of the low boiling point substance removal column 71, the fraction B′ containing isoprene of high purity is discharged from the column top of the distillation column 72, the fraction D′ containing the intermediate boiling point impurity is discharged from the column top of the intermediate boiling point substance removal column 73, the fraction E′ containing the solvent of high purity is discharged from the column top of the high boiling point substance removal column 74, and the fraction F′ containing the impurity higher in boiling point than the collection target component is discharged from the column bottom of the high boiling point substance removal column 74.

After continuous operation for one year, the device was stopped and the inside of the distillation column was visually examined. The amount of polymerization foreign matter of isoprene formed was smaller in Example 1 than in Comparative Example 1.

### INDUSTRIAL APPLICABILITY

With the production method and production device for a polymer according to the present disclosure, at least one of a residual monomer and a solvent can be efficiently separated and collected from a polymer-containing liquid obtained by polymerizing a raw material monomer and reused.

### REFERENCE SIGNS LIST

10 reactor

20 tank

30 separator

40, 50 three-product distillation column

60, 61, 62 return line

71 low boiling point substance removal column

72 distillation column

73 intermediate boiling point substance removal column

74 high boiling point substance removal column

100, 200, 300 production device

1. A production method for a polymer, comprising:
a step (A) of polymerizing a raw material monomer to obtain a polymer-containing liquid containing a polymer;
a step (B) of separating a collection target component-containing fluid containing a collection target component composed of at least one of a solvent and a residual monomer, from the polymer-containing liquid;
a step (C) of supplying the collection target component-containing fluid to a three-product distillation column, and separating a fraction containing an impurity higher in boiling point than the collection target component and a fraction containing an impurity lower in boiling point than the collection target component, to obtain a fraction containing the collection target component of high purity; and
a step (D) of performing polymerization using the fraction containing the collection target component of high purity.

2. The production method for a polymer according to claim 1, wherein the collection target component-containing fluid contains a first collection target component and a second collection target component lower in vapor pressure than the first collection target component, and
the step (C) includes:
a step (c1) of supplying the collection target component-containing fluid to a first three-product distillation column, and obtaining a fraction containing an impurity lower in boiling point than the first collection target component, a fraction containing the first collection target component of high purity, and a fraction containing the second collection target component; and
a step (c2) of supplying the fraction containing the second collection target component to a second three-product distillation column, and obtaining a fraction containing an impurity higher in boiling point than the second collection target component, a fraction containing the second collection target component of high purity, and a fraction containing an impurity lower in boiling point than the second collection target component.

3. The production method for a polymer according to claim 1, wherein the collection target component-containing fluid contains the solvent and the residual monomer, and
the step (C) includes:
a step (c3) of obtaining a fraction containing the residual monomer of high purity using the three-product distillation column; and
a step (c4) of obtaining a fraction containing the solvent of high purity using the three-product distillation column, after the step (c3).

4. The production method for a polymer according to claim 1, wherein the solvent is an organic compound with a carbon number of 4 or more and 7 or less.

5. The production method for a polymer according to claim 1, wherein the raw material monomer has a carbon number of 4 or more and 5 or less.

6. A production device for a polymer, comprising:
a polymerization portion including a reactor that polymerizes a raw material monomer;
a separation portion including a separator that separates, from a polymer-containing liquid containing a polymer obtained by the polymerization portion, a collection target component-containing fluid containing a collection target component composed of at least one of a solvent and a residual monomer;
a three-product distillation portion including a three-product distillation column supplied with the collection target component-containing fluid obtained by the separation portion, and separating, from the collection target component-containing fluid, a fraction containing an impurity higher in boiling point than the collection target component and a fraction containing an impurity lower in boiling point than the collection target component, to obtain a fraction containing the collection target component of high purity; and
a return line that supplies the fraction containing the collection target component of high purity to the reactor.
